(19) United States
(12) Patent Application Publication
(10) Pub. No.: US 2011/0022283 A1
(43) Pub. Date: Jan. 27, 2011

(54) SYSTEM AND METHOD FOR CONDITIONING RELEASE OF A PARK BRAKE

(75) Inventor: Steven Randall Lovell, Fort Wayne, IN (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 12/509,084

(22) Filed: Jul. 24, 2009

(51) Int. Cl. G06F 19/00

(52) U.S. Cl. 701/70

(57) ABSTRACT

A vehicle has at least one road wheel on which the vehicle travels and a park brake for selectively locking the at least one road wheel while the vehicle is parked. An actuator can apply the park brake to lock the at least one road wheel, and can release the park brake to unlock the at least one road wheel. An electronic controller interfaces the actuator with a wheel locking mechanism. The status of a variable status device, such as a lift platform, is communicated to the electronic controller and is effective on the electronic controller for causing the electronic controller to disallow park brake release by the actuator when a first status is communicated to the electronic controller and to allow park brake release by the actuator when a second status is communicated to the electronic controller.

### TECHNICAL FIELD

The subject matter of this disclosure relates to wheeled vehicles that have one or more mechanisms associated with one or more wheels on which the vehicle travels for selectively locking a wheel against rotation while the vehicle is parked, such mechanism, or mechanisms, being commonly called park brakes, or park brake systems. In particular the disclosure relates to a system and method for conditioning release of a park brake.

### BACKGROUND OF THE DISCLOSURE

A typical park brake system in a vehicle such as a commercial truck or bus comprises an actuator that is available to the driver for applying and releasing the park brake. A park brake knob is one example of such an actuator.

Various types of mechanisms are available for coupling a driver-operated actuator to a wheel or wheels that is or are to be locked against rotation when a vehicle is parked. Actual locking may take place directly at a wheel or wheels, or at a device in the vehicle, such as a transmission, that is directly coupled to a wheel or wheels that is or are to be locked.

Mechanisms may include mechanical, pneumatic, and/or hydraulic components or various combinations of such components. In certain vehicles the park brake system uses an on-board pressurized air supply to keep a park brake at each wheel from otherwise being automatically applied by a device, sometimes called a SAAR (meaning Spring-Actuated, Air-Released) for short. Application of the park brakes at the wheels occurs when the air supply to the SAAR is shut off, allowing the spring force of the SAAR to be effective to lock the wheels. Pressurized air is applied to the SAAR in order to release the park brake.

Another type of park brake system device called a SAHR (meaning spring-actuated, hydraulic-released) uses hydraulic fluid instead of air.

### SUMMARY OF THE DISCLOSURE

Embodiments disclosed herein relate to a system and a method for conditioning release of a park brake of a vehicle. In one embodiment, the system comprises a park brake for selectively locking at least one road wheel on which the vehicle travels while the vehicle is parked. An actuator applies the park brake to lock the at least one road wheel, and releases the park brake to unlock the at least one road wheel. An electronic controller interfaces the actuator with a wheel locking mechanism of the park brake. A variable status device is provided whose status is communicated to the electronic controller and is effective on the electronic controller for causing the electronic controller to disallow park brake release by the actuator when a first status of the variable status device is communicated to the electronic controller and to allow park brake release by the actuator when a second status of the variable status device is communicated to the electronic controller.

Another embodiment provides a method of conditioning release of a park brake that has been applied by an actuator acting via an electronic controller on a mechanism that is locking at least one road wheel of a vehicle on which the vehicle can travel. One such method comprises communicating status of a variable status device to the electronic controller and causing the electronic controller to disallow park brake release by the actuator when a first status of the variable status device is communicated to the electronic controller and to allow park brake release by the actuator when a second status of the variable status device is communicated to the electronic controller.

### BRIEF DESCRIPTION OF THE DRAWINGS

FIG. 1 shows a truck having a system and method of conditioning release of a park brake.

FIG. 2 is a general schematic diagram of the system and method of conditioning release of a park brake.

### DETAILED DESCRIPTION

In general, embodiments disclosed herein relate to a system and a method for conditioning release of a vehicle's park brake. In some embodiments, the vehicle's park brake system has an electronic park brake controller through which a park brake actuator is accessible to a driver of the vehicle. The park brake actuator selectively locks and unlocks one or more road wheels of the vehicle. With the park brake being applied, any device, such as a lift platform, that is appropriate for conditioning park brake release by the actuator on a certain status of the device, such as the lift platform being in stowed position, can disallow park brake release until that device status is disclosed to the park brake controller. In the case of the lift platform for example, failure to disclose that the lift platform has been stowed can disallow park brake release.

Disclosure of the status of a device can be provided via hard-wired connection directly to the controller from a switch or sensor for example suitably associated with the device.

Disclosure can also be provided via a data bus that enables the controller to read electronically data disclosing the status of a particular device. An electronic controller interfaces the actuator with a wheel locking mechanism of the park brake. A variable status device whose status is communicated to the electronic controller is effective on the electronic controller for causing the electronic controller to disallow park brake release by the actuator when a first status of the variable status device is communicated to the electronic controller, and to allow park brake release by the actuator when a second status of the variable status device is communicated to the electronic controller.

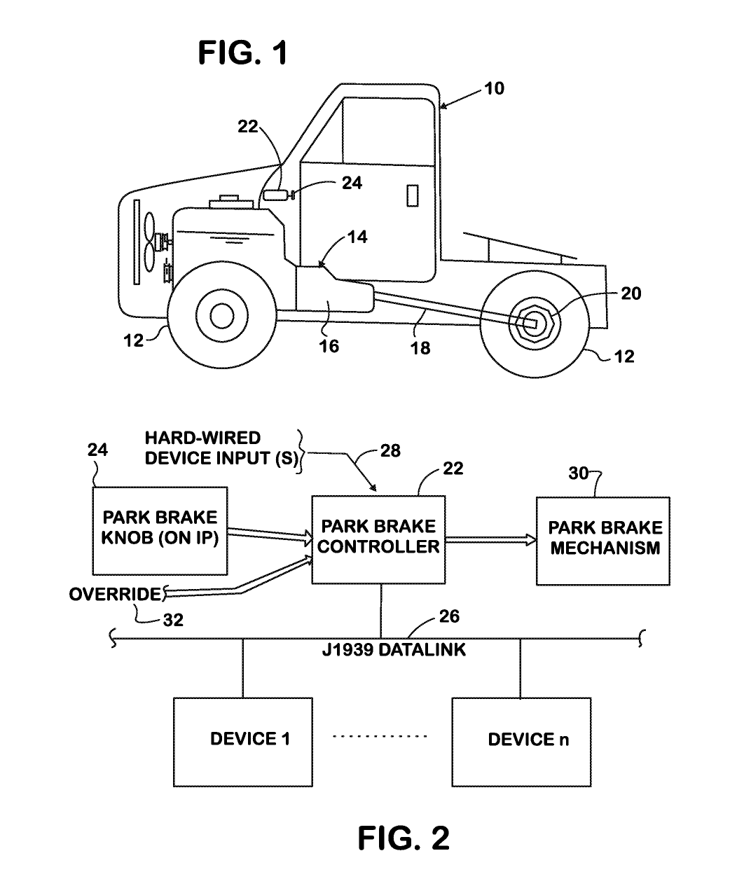

FIG. 1 shows a truck 10 having road wheels 12 on which the truck travels when propelled by a powertrain 14. When truck 10 is parked, a park brake can be applied to lock one or more wheels 12 against rotation.

Representative park brakes include individual locking mechanisms at wheels 12 and mechanisms associated with powertrain components that are directly coupled to driven wheels 12 for locking those components against rotation. For example, a pawl (not shown) associated with a transmission 16 in powertrain 12 can lock the transmission output that is coupled to the truck's rear wheels 12 via a driveshaft 18 and axle 20. The park brake mechanism can also act on the vehicle driveline.

The park brake of truck 10 comprises an electronic park brake controller 22 through which a park brake actuator 24 that is accessible to a driver seated inside the truck cab can signal the controller to selectively lock and unlock wheels 12. Actuator 24 is shown by way of example as a park brake knob 24 on an instrument panel (IP) inside the cab. When knob 24 is pulled out for example, it acts on controller 22 to cause controller 22 to apply the park brake, and when it is pushed in, it causes controller 22 to release the park brake.

Truck 10 may have one or more devices, shown generically in FIG. 2 as Device 1. Device n, that are appropriate for conditioning park brake release by park brake knob 24 on a certain status of each device. The lift platform described above is one example of such a device.

The park brake release conditioning system disclosed herein is shown in FIG. 2 to comprise a communicative association of such Devices with controller 22 either via a data bus 26 or hard wire 28. The association is made for the purpose of conditioning park brake release on any such Device signaling to controller 22 that the status of the Device is inappropriate for allowing the park brake, if being applied by knob 24 having been pulled out, to be released by pushing knob 24 in.

Hence, when knob 24 is pulled out, controller 22 operates whatever mechanism 30 is (or mechanisms are) present in truck 10 to mechanically lock wheels 12. When knob 24 is pushed in, controller 22 causes the mechanism or mechanisms to unlock wheels 12 provided that none of the Devices is disclosing to controller 22 that its status is such that the mechanism(s) 30 should not be released from keeping the wheels locked. In other words, when knob 24 is pushed in, all Devices must concur that the park brake can be released before controller 22 actually releases the park brake.

The disclosed park brake release conditioning system is therefore effective on controller 22 to cause the controller to disallow park brake release by actuator 24 when a first status of at least one Device is communicated to the controller and to allow park brake release by the actuator when a second status of each of the Devices is communicated to the controller.

If at the time that knob 24 is pushed in to release the park brake, the status of a Device is one that doesn't disallow release, but that status is for whatever reason, such as loss of connection, not disclosed to controller 22, the controller will keep the park brake applied. The occurrence of such an event may be indicated by an appropriate indicator, such as a lamp or display in the instrument panel. In order to allow park brake release in such a situation, an override 32 is provided.

This allows the driver to investigate and determine if the override should be used. If so, the override will nullify the failure of controller 22 to have received the proper status for allowing the park brake to be released. The override may be given to controller 22 in any of various ways such as by ignition key cycling, a devoted override switch, etc.

What is claimed is:

1. A system for conditioning release of a park brake of a vehicle, the system comprising:
a park brake for selectively locking at least one road wheel on which the vehicle travels while the vehicle is parked;
an actuator for applying the park brake to lock the at least one road wheel, and for releasing the park brake to unlock the at least one road wheel;
an electronic controller interfacing the actuator with a wheel locking mechanism of the park brake; and
a variable status device whose status is communicated to the electronic controller and is effective on the electronic controller for causing the electronic controller to disallow park brake release by the actuator when a first status of the variable status device is communicated to the electronic controller and to allow park brake release by the actuator when a second status of the variable status device is communicated to the electronic controller.

2. The vehicle set forth in claim 1 further comprising:
multiple variable status devices each of whose status is communicated to the electronic controller and is effective on the electronic controller to disallow park brake release by the actuator when the first status of at least one of the multiple variable status devices is communicated to the electronic controller and to allow park brake release by the actuator when the second status of each of the multiple variable status devices is communicated to the controller.

3. The vehicle set forth in claim 1 further comprising:
an override device for giving an override signal to the electronic controller that is effective to cause the electronic controller to disallow the first status of the variable status device from disallowing park brake release by the actuator.

4. A method of conditioning release of a park brake that has been applied by an actuator acting via an electronic controller on a mechanism that is locking at least one road wheel of a vehicle on which the vehicle can travel, the method comprising:
communicating status of a variable status device to the electronic controller and causing the electronic controller to disallow park brake release by the actuator when a first status of the variable status device is communicated to the electronic controller and to allow park brake release by the actuator when a second status of the variable status device is communicated to the electronic controller.

5. The method set forth in claim 4 further comprising:
communicating status of each of multiple variable status devices to the electronic controller and causing the electronic controller to disallow park brake release by the actuator when the status of at least one of the multiple variable status devices communicated to the electronic controller is the first status and to allow park brake release by the actuator when the status of each of the multiple variable status devices communicated to the electronic controller is the second status.

6. The method set forth in claim 4 further comprising:
giving an override signal to the electronic controller that is effective to cause the electronic controller to disallow the first status of the variable status device from disallowing park brake release by the actuator.
